(19) United States
(12) Patent Application Publication
(10) Pub. No.: US 2007/0187555 A1
(43) Pub. Date: Aug. 16, 2007

(54) Securing elements to pipes or tubes

(76) Inventor: Raymond Rabanin, Hampton Park (AU)

Correspondence Address: KIRK HAHN, 14431 HOLT AVE, SANTA ANA, CA, 92705, US

(21) Appl. No.: 10/598,829

(22) PCT Filed: Mar. 12, 2005
(86) PCT No.: PCT/AU05/00343

§ 371 Date: Sep. 12, 2006

(30) Foreign Application Priority Data
Mar. 12, 2004 (AU) 2004901265

(51) Int. Cl. F16L 3/00

(52) U.S. Cl. 248/49

(57) ABSTRACT

The invention provides a securing device (1) for securing items to an elongate element (2). The securing device comprises first and second parts (3, 4) positionable in co-operating engagement with each other and adjacent to the elongate element. The two parts when in engagement with each other are movable relative to each other in a longitudinal direction of the elongate element. The two parts are shaped so that this relative movement generates lateral relative movement of the two parts towards each other so that the elongate member is gripped between the parts. The invention permits rapid securing of items to elongate elements such as tubes. A particular application provides a cable support for use on tubular scaffolding. In its preferred form the cable support is a device as above and having spaced fingers (5) on one of the two parts, between which cables (7) can be inserted, retained and supported.

### TECHNICAL FIELD

This invention relates to a securing device for use on structures containing elongate elements in particular tubes or pipes. The securing device is quickly and easily securable to such an element and may be incorporated in an item to be connected to the element or may provide a support or connection point for securing an item on or to the element. It is particularly directed to use on scaffolding and other structures formed from tubing.

### BACKGROUND ART

It is often required to make a physical connection to a structure that Includes an elongate element such as a pipe or tube. As an example, scaffold structures are temporarily erected on buildings and other structures under construction or repair to provide workers with access to working areas not otherwise reachable. Most scaffolding structures are assembled from lengths of tubing connected to each other by specialized clamps.

For safety, it is recognized as highly desirable to secure electric cables, hoses and the like in positions that will prevent them from posing tripping hazards on walkways of scaffold structures. It is possible to tie such items to the scaffold structure, but this approach can be slow and of uncertain reliability. Moreover, as the work advances or as different trades require changes to the runs of hoses and cables, they may need to be secured in new positions. It is desirable that this be able to be done easily and quickly.

The present invention provides a securing device, and a cable support incorporating the securing device, that can in many cases meet such requirements. While the invention is particularly directed to providing support for cables hoses and the like on scaffold structures, embodiments can be used also to provide support for junction boxes, signs, lighting, temporary barriers and virtually anything that needs to be anchored on the scaffold structure.

Moreover, the invention is believed also to have applications to other structures formed of elongate elements, such as furniture and temporary fencing.

### DISCLOSURE OF INVENTION

The invention provides a securing device for securing items to an elongate element said securing device comprising first and second parts positionable in co-operating engagement with each other and adjacent to an elongate element said parts when in engagement with each other being movable relative to each other in a longitudinal direction of said element, said first and second parts being shaped so that relative movement of said parts in said longitudinal direction generates lateral relative movement of said parts towards each other so that said elongate member is gripped between said parts.

In a preferred form of the invention, said first and second parts in combination when co-operatingly engaged with each other surround said elongate element. That is, the device when assembled to the elongate element acts as a collar surrounding the elongate element.

It is particularly preferred that said first part has an inclined surface that in co-operating engagement between said first and second parts contacts said second part and that is inclined relative to said longitudinal direction so that that during said relative movement of said parts in said longitudinal direction said first and second parts are drawn together whereby to grip said elongate member.

Said inclined surface of said first part may contact an inclined surface of said second part when said first and second parts are in co-operating engagement so that during said relative longitudinal movement of said parts said inclined slide on each other.

Conveniently, said inclined surface of said first part may be a surface of a wedge formation on said first part.

Said wedge formation may be received in a recess of said second part when said first and second parts are In cooperating engagement.

Said wedge formation may be one of two such wedge formations in said securing device.

Said wedge formation in use of the securing device may project outwardly of said elongate element.

In one preferred form of the invention, said inclined surface of said first part is one of two such inclined surfaces of said first part that in co-operating engagement of said first and second parts contact the second part. In an alternative form of the invention, said second part has an inclined surface that in co-operating engagement between said first and second parts contacts said first part In any of these forms of the invention, it is preferred that when said securing device is in use to grip an elongate element of circular cross-section said two inclined surfaces are at least approximately diametrically opposed to each other.

Preferably, at least one of the first and second parts has a shaped surface that when said securing device is in use to grip said elongate element conformingly abuts an external surface of the elongate element.

In a particularly useful form of the invention, the or at least one shaped surface is part-cylindrical in shape so that said securing device is adapted in use to conformably abut an elongate element of substantially circular cross-section.

The invention has many applications. Accordingly in a further aspect of the invention, there is provided a securing means for securing an item to an elongate element comprising a securing device in any of the forms disclosed above and means for securing said item to said securing device.

As an example of a particularly useful application, the invention provides a cable support for use on scaffold tubes and other elongate elements comprising a securing device in any of the forms disclosed herein and comprising cable support means on at least one of said first and second parts for supporting cables.

Preferably, the cable support has on at least one of said first and second parts a plurality of fingers shaped and positioned to retain cables between adjacent fingers. The fingers may be spaced apart in the longitudinal direction. The said fingers on a said part may be integrally formed with said part. Without in any way limiting the scope of the invention, the cable support may, for example, be made by injection molding the first and second parts in plastics.

In a further aspect, the invention provides a connector for connecting a plurality of components of which at least one component is elongate, the connector comprising firstly a securing device in any of the forms disclosed herein for securing to said elongate component and secondly holding means secured to or comprised in said first or second part of the securing device and adapted to hold another of said components.

Although mainly directed to assemblies and connectors that are able to be fully disassembled, the first and second parts may also be left permanently connected after assembly, for example by adhesive (including solvent adhesive) or by providing one or more cooperating ratchet-like teeth on (for example) the first and second parts.

It is also possible to include in the securing device means for positively holding the first and second parts together and for applying force in the longitudinal direction to cause them to grip the elongate element.

In a further aspect, the invention provides a method for securing an item to an elongate element comprising the steps of:
(a) providing a securing device in any of the forms disclosed herein;
(b) positioning said first and second parts adjacent to said elongate element and in engagement with each other;
(c) moving said first and second parts relative to each other in a longitudinal direction of said element until said element is gripped between said first and second parts; and
(d) securing said item to said securing device.

In yet a further aspect, the invention provides a method for temporarily supporting cables on an elongate element comprising the steps of:
(a) providing a cable support in any of the forms disclosed above;
(b) positioning said first and second parts adjacent to said elongate element and in engagement with each other;
(c) moving said first and second parts relative to each other in a longitudinal direction of said element until said element is gripped between said first and second parts; and
(d) supporting cables by the cable support means comprised in said cable support.

In order that the invention can be better understood it will now be described non-limitingly by reference to preferred embodiments as shown in the attached Figures.

### BRIEF DESCRIPTION OF DRAWINGS

FIG. 1 is a perspective view of a securing device, configured as a cable support, according to the invention;

FIG. 2 is a perspective view of the securing device shown in FIG. 1, in use as a cable support;

FIG. 3 is a perspective view of a first part of the colt arassembly shown in FIG. 1;

FIG. 4 is a perspective view of a second part of the securing device shown in FIG. 1;

FIG. 5 is a cross-sectional view of the securing device of FIG. 1 taken at station “AA”, with tube 2 omitted;

FIG. 6 is a side view of a connector including collar assemblies according to the invention, the connector itself according with one aspect of the invention;

FIG. 7 is a perspective view of a further embodiment of a securing device according to the invention.

### BEST MODE FOR CARRYING OUT THE INVENTION

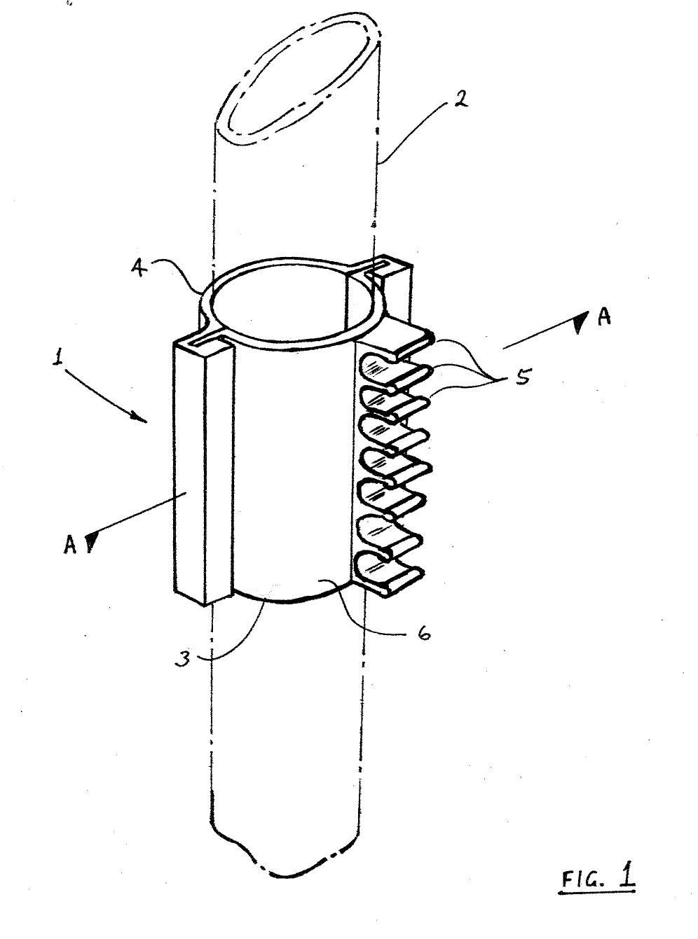

FIG. 1 shows a securing device 1 according to the invention, secured to a tube 2 (shown in phantom lines) such as might be found in a scaffold or temporary fence structure. The securing device 1 is secured (by means set out below) to tube 2, and has formations 5 (see below) for supporting cables. That is, device 1 is a cable support. It is to be understood, however, that securing devices based on the same principle as device 1 may be applied to the support or connection of equipment or items other than cables in scaffolding and like applications. Although the cable support application is important, the description below of device 1 is illustrative and not intended to restrict the scope of the invention to cable supports.

Securing device 1 has first and second parts 3 and 4 respectively that when assembled together form the securing device 1. First part 3 includes eight fingers 5 spaced apart along, and extending outwardly from, a half-cylinder 6.

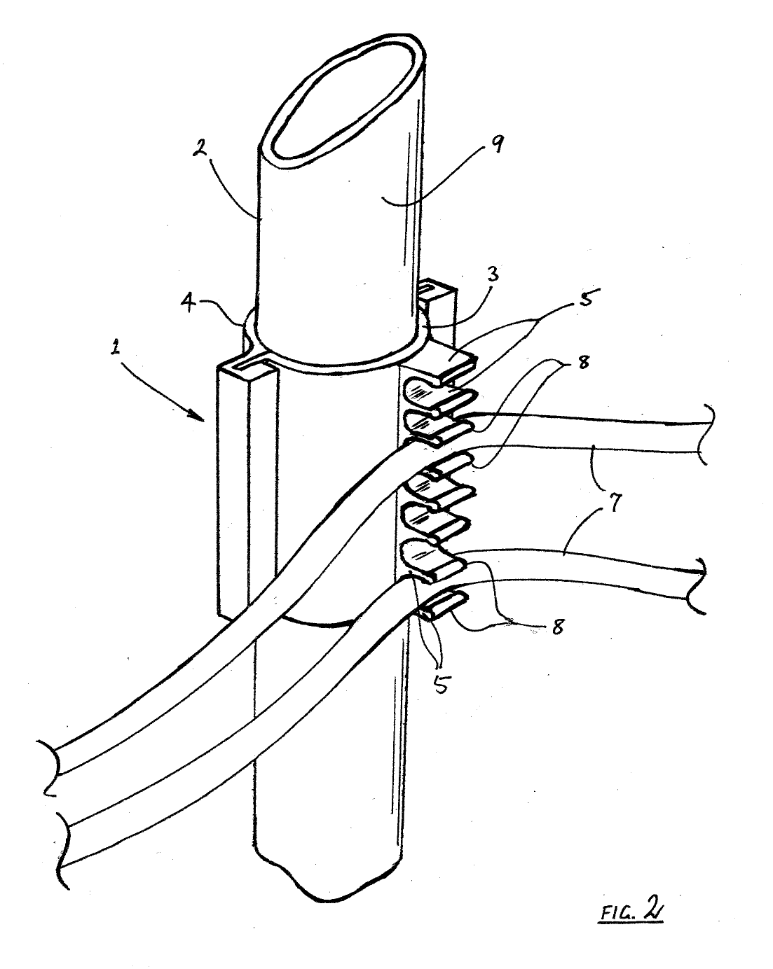

FIG. 2 shows securing device 1 in use to support two electric power cables 7. Securing device 1 can support up to seven cables 7 if all eight fingers 5 are used, each cable being retained between two of the fingers 5. Each finger 5 includes an integral formation 8 at its free end so shaped that the distance between formations 8 of each adjacent pair of fingers 5 is slightly less than the distance between those fingers 5 themselves at points thereon closer to half-cylinder 6, so that once placed between a pair of fingers 5, a cable 7 is retained there. The fingers 5 are somewhat flexible and resilient due to a suitable choice of dimensions and material, and suitably spaced, so as to grip and retain cables 7 securely, while still allowing a cable 7 to be simply pulled away from the half-cylinder 6, and so released from securing device 1, when required.

Half-cylinder 6 has a half-cylindrical concave surface 8 that in use of securing device 1 as shown in FIGS. 1 and 2 lies conformingly against the cylindrical outer surface 9 of tube 2.

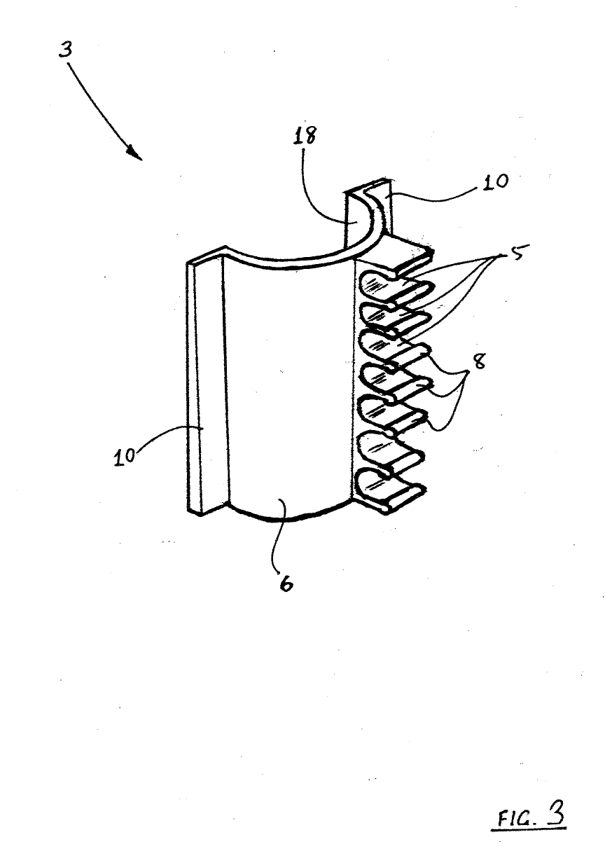

FIG. 3 shows first part 3 alone, and in this Figure can best be seen elongate wedges 10 that protrude from half-cylinder 6 and extend along the length of half-cylinder 6 along its opposite edges. Wedges 10 increase progressively in thickness along the length of half-cylinder 6, both having their maximum thickness at the same end of half-cylinder 6.

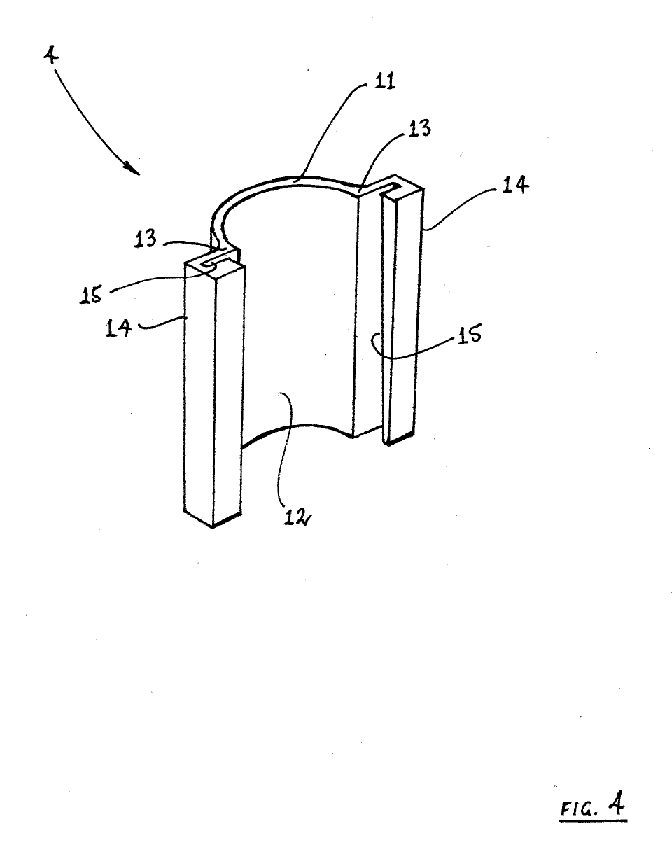

FIG. 4 shows second part 4 alone. Second part 4 Includes a part-cylindrical section 11 having a concave surface 12 that in use of securing device 1 (as shown in FIGS. 1 and 2) lies conformingly against the outer surface 9 of tube 2.

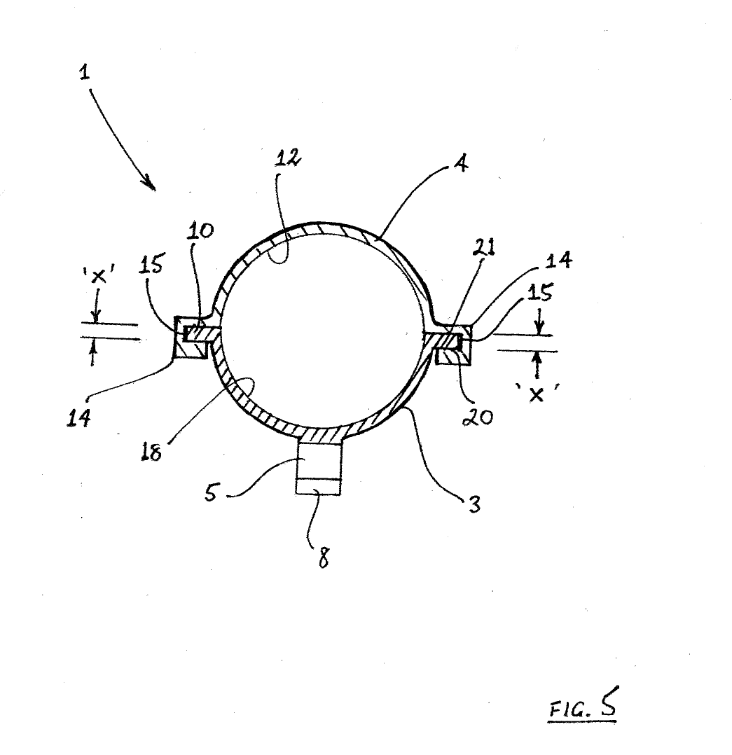

Extending along, and integral with, edges 13 of the part-cylindrical section 11 are elongate formations 14. As can be seen in FIG. 5, each of formations 14 is channel-shaped in cross-section, with a recess 15 extending along its length and sized and oriented to receive therein one of the wedges 10 of first part 3. The dimension “x” (see FIG. 5) of each of the recesses 15 varies progressively along the recess's length, each in the same direction so that the largest value of “x” is at the same end of each recess 15.

Securing device 1 can be assembled and secured to tube 2 in the following manner. First part 3 is placed against tube 2, in any desired position therealong, with concave surface 18 lying conformably against outer surface 9 of tube 2. Next, second part 4 is moved towards first part 3 from the opposite side of tube 2, in such an orientation that the thinner ends of wedges 10 are positioned to enter the thicker ends of recesses 15. Finally, second part 4 is moved lengthwise along the tube 2 and further into engagement with first part 3. Parts 3 and 4 are pulled inward toward tube 2 by the sliding of inclined surface 20 of wedges 10 against the inclined surfaces 21 of part 4 within recesses 15. This process continues until until wedges 10 are firmly gripped in recesses 15. At this point, the surfaces 18 and 12 of parts 3 and 4 respectively lie conformably against outer surface 9 of tube 2, and securing device 1 is assembled and securely held to tube 2. The securing device 1 is then ready for use.

Of course, either the first half 3 or the second half 4 may be positioned first, and either or both may be moved longitudinally to complete the above procedure.

The securing device 1 lends itself well to manufacture by injection moulding in suitably-selected plastics materials.

Variations in design may be made. For example, although the wedges 10 and formations 14 of securing device 1 are shown as being approximately diametrically opposite, different positions may be chosen. For example (although not shown) if part 3 extended peripherally further around tube 2 and part 4 correspondingly less further around tube 2, part 3 could be made to dip on to tube 2, with part 4 then being assembled to part 3 to complete the securing device and tighten its securing action on tube 2.

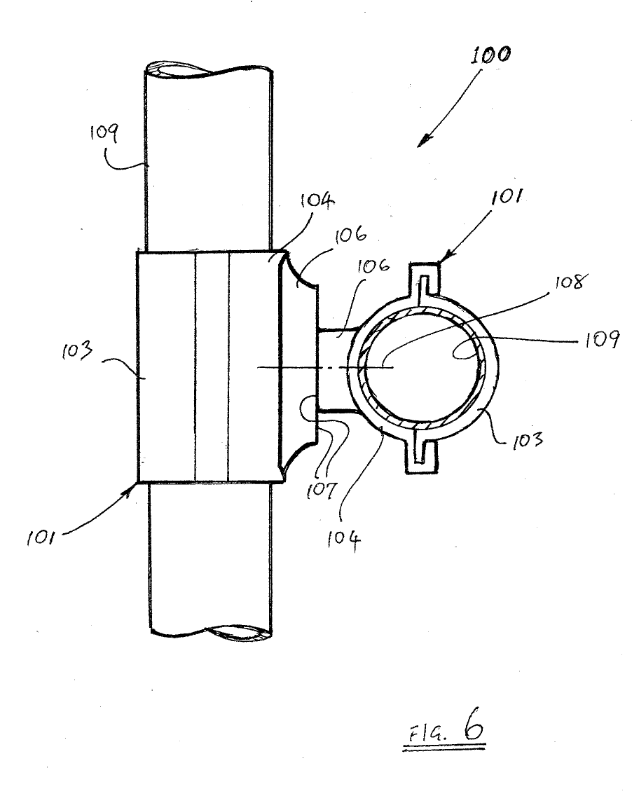

The principle of securing device I is not limited to the particular application of a cable support as described above. As a further example of its possible use, FIG. 6 shows a connector 100 that includes two securing devices 101. Each device 101 is similar to cable support 1, described above, in having two halves 103 and 104 corresponding to parts 3 and 4 of assembly 1, but differs In not having the fingers 5. Instead, formations 106 integrally formed as part of parts 104 abut at faces 107 and are held together by a pin or bolt (not shown) that extends along an axis 108. Connector 100 connects two tubes 109 that are shown at right angles to each other but that could be at some other angle if required, each assembly 101 pivoting about the bolt/pin to assume the appropriate angle. Each device 101 is secured around its associated tube 109 in the same way as cable support 1 is secured to tube 2. A connector such as connector 100 could find many applications, such as connecting temporary fence modules that incorporate tubular elements, connecting parts of lightweight temporary structures (eg portable display stands) or in furniture.

Many items that are to be secured to elongate elements such as junction boxes, light fittings and the like (not shown) may have one of the parts (i.e. corresponding to parts 3 or 4) of a securing device on the principle of securing device 1 incorporated into them, the other part then being assembled thereto.

As will readily be apparent, many other variations may be made without departing from the spirit or scope of the present invention.

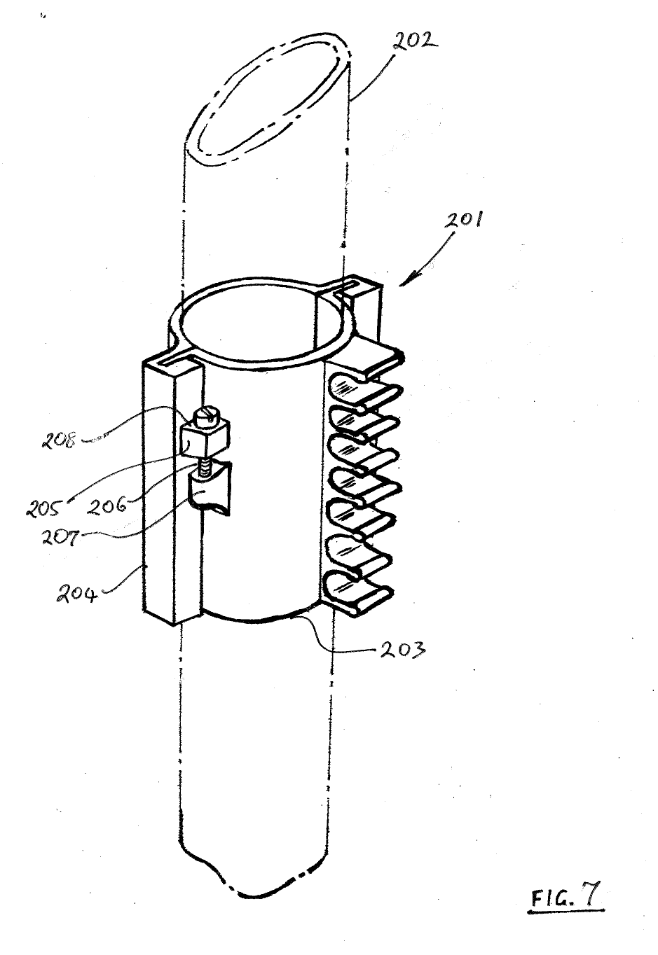

FIG. 7 shows one possible variation. The figure shows a securing device 201 directly comparable with securing device 1 and having first and second parts 203 and 204 corresponding in their functions to parts 3 and 4 of securing device 1. Formed integrally with part 204 is a lug 205 and formed integrally with part 203 is a second lug 207. A screw 206 is threadably engaged with lug 207 and passes through a clearance hole (not visible) in lug 205. Screw 206 is screwed into the position shown after the two parts 203 and 204 are positioned around element 202 exactly in the way described above for securing device 1. When screw 206 is tightened, its head 209 bearing against face 208 of lug 205, it tightens the grip of securing device 201 on element 202, and also acts as a locking element to prevent accidental separation of parts 203 and 204. Although not shown in FIG. 7, a similar arrangement may be provided on the opposite side of device 201.

In this specification, the word “comprise” (or any of its derivatives, e.g. “comprising”) when used in relation to integers elements or items of a system method apparatus or device is to be taken not to preclude, the possibility that other integers elements or items are present in the device method or system being described.

1. A securing device for securing items to an elongate element said securing device comprising first and second parts positionable in co-operating engagement with each other and adjacent to an elongate element said parts when in engagement with each other being movable relative to each other in a longitudinal direction of said element, said first and second parts being shaped so that relative movement of said parts in said longitudinal direction generates lateral relative movement of said parts towards each other so that said elongate member is gripped between said parts.

2. The securing device of claim 1 wherein said first and second parts in combination when co-operatingly engaged with each other surround said elongate element.

3. The securing device of claim 1 wherein said first part has an inclined surface that in co-operating engagement between said first and second parts contacts said second part and that is inclined relative to said longitudinal direction so that that during said relative movement of said parts in said longitudinal direction said first and second parts are drawn together whereby to grip said elongate member.

4. The securing device of claim 3 wherein said inclined surface of said first part contacts an inclined surface of said second part when said first and second parts are in co-operating engagement and wherein during said relative longitudinal movement of said parts said inclined surfaces slide on each other.

5. The securing device of claim 3 wherein said inclined surface of said first part is a surface of a wedge formation on said first part.

6. The securing device of claim 5 wherein said wedge formation is received in a recess of said second part when said first and second parts are in cooperating engagement.

7. The securing device of claim 5 wherein said wedge formation is one of two such wedge formations in said securing device.

8. The securing device of claim 5 wherein the or at least one said wedge formation in use of the securing device projects outwardly of said elongate element.

9. The securing device of claim 3 wherein said inclined surface of said first part is one of two such inclined surfaces of said first part that in co-operating engagement of said first and second parts contact the second part.

10. The securing device of claim 3 wherein said second part has an inclined surface that in co-operating engagement between said first and second parts contacts said first part.

11. The securing device of claim 9 wherein when said securing device is in use to grip an elongate element of circular cross-section said two inclined surfaces are at least approximately diametrically opposed to each other.

12. The securing device of claim 1 wherein at least one of the first and second parts has a shaped surface that when said securing device is in use to grip said elongate element conformingly abuts an external surface of the elongate element.

13. The securing device of claim 12 wherein the or at least one shaped surface is part-cylindrical in shape so that said securing device is adapted in use to conformably abut an elongate element of substantially circular cross-section.

14. A securing means for securing an item to an elongate element comprising the securing device of claim 1 and means for securing said item to said securing device.

15. A cable support for use on scaffold tubes and other elongate elements comprising the securing device of claim 1 and comprising cable support means on at least one of said first and second parts for supporting cables.

16. The cable support of claim 15 having on at least one of said first and second parts a plurality of fingers shaped and positioned to retain cables between adjacent fingers.

17. The cable support of claim 16 wherein the fingers are spaced apart in the longitudinal direction.

18. The cable support of claim 16 wherein the said fingers on a said part are integrally formed with said part.

19. A connector for connecting a plurality of components of which at least one component is elongate, the connector comprising firstly the securing device of claims 1 for securing to said elongate component and secondly holding means secured to or comprised in said first or second part of the securing device and adapted to hold another of said components.

20. (canceled)

21. A method for securing an item to an elongate element comprising the steps of:
(a) providing the securing device of claim 1;
(b) positioning said first and second parts adjacent to said elongate element and in engagement with each other;
(c) moving said first and second parts relative to each other in a longitudinal direction of said element until said element is gripped between said first and second parts; and
(d) securing said item to said securing device.

22. A method for temporarily supporting cables on an elongate element comprising the steps of:
(a) providing the cable support of claim 15;
(b) positioning said first and second parts adjacent to said elongate element and in engagement with each other;
(c) moving said first and second parts relative to each other in a longitudinal direction of said element until said element is gripped between said first and second parts; and
(d) supporting cables by the cable support means comprised in said cable support.
